(19) United States
(12) Patent Application Publication
(10) Pub. No.: US 2012/0213417 A1
(43) Pub. Date: Aug. 23, 2012

(54) Biometric Electronic Skimming Station

(75) Inventors: Robert William Kocher, JR., Arlington, VA (US); David Simon, Alexandria, VA (US)

(73) Assignee: Ideal Innovations Incorporated, Arlington, VA (US)

(21) Appl. No.: 13/398,091

(22) Filed: Feb. 16, 2012

Related U.S. Application Data
(60) Provisional application No. 61/443,267, filed on Feb. 16, 2011.

(51) Int. Cl. G06K 9/00

(52) U.S. Cl. 382/115

(57) ABSTRACT

A biometric and electronic sensor system, which detects the presence of a subject and collects electronic signatures and biometric information of the subject, and the electronic signatures and the biometric information of the subject are compared by a computer program code to those of records contained in a database to determine whether a match exists.

### CROSS-REFERENCE TO RELATED APPLICATIONS

This application claims priority to provisional patent application No. 61/443,267 filed 16 Feb. 2011.

### BACKGROUND

Enrollment in current biometric identification management systems uses small groups of enrollers, approximately four to six people, to manually operate devices that capture biometric information such as fingerprints, facial images, and iris scans. These people also manually collect biographical information for the subjects being enrolled such as name, social security number, address, phone number, date of birth, and related information. Often this information is collected on paper and then manually entered into the biometric collection device. Combined, this process takes about 10-20 minutes for each enrollee. It also involves segregating the people being enrolled from the rest of the population of potential enrollees and having them submit to a biometric collection process and respond to questions about their personal biographical information. As a whole, enrollment using current biometric identification management systems has the undesirable characteristics of requiring large amounts of time and being perceived as unreasonably intrusive. These undesirable characteristics are only amplified when the potential enrollees number in the hundreds or more, or the enrollments take place in areas stricken by military or terrorist conflicts.

Several factors contribute to the time it takes to enroll individuals and the perception of intrusiveness of doing so. The first and perhaps most significant of these factors is that enrollment only occurs at specific points, namely the checkpoints where enrollers are operating. At enrollment locations such as border crossings there may be hundreds or even thousands of potential enrollees waiting in line in vehicles and on foot, while they methodically make their way past a specific enrollment checkpoint. At some border crossings in areas stricken by military or terrorist conflicts, it is not unusual for people to wait days before crossing the border. This restriction on where the enrollment takes place and how many enrollees are enrolled at any given time severely affects the amount of time it takes to enroll large numbers of people.

A second important factor is the manual process used to collect the biometric and biographical information. Because of the enrollment devices currently employed, an enrollee must stop, submit his hands for fingerprinting, present his face for imaging and eyes for iris scanning, then answer biographical questions given by the enroller. Not only does this process take significant amounts of time, but it also creates apprehension on the part of the enrollee. In some contexts such as border crossings between nations, language and culture differences may keep the enrollee from fully understanding what is being collected or why the information is being collected. These differences may also exacerbate the implicit adversarial perceptions people have in any interview process. In addition, the personal nature of the biographical information that is sought may make the enrollment process seem invasive even when the information is otherwise publically available. All of these factors combine to lengthen the amount of time necessary for each individual enrollment and significantly contribute to the perception of the process as intrusive.

Thus, it is desirable to enable enrollment in biometric identification management systems to take place at many locations and of many enrollees simultaneously. It is also desirable to reduce or eliminate the dependence of the enrollment process on the actions of human enrollers. Further it is desirable to collect biometric and biographic information without contacting the enrollees, without requiring them to stop, and without the enrollees being aware that biometric or biographical information is being collected.

### SUMMARY

According to an embodiment of the present disclosure, a method for biometric and electronic enrollment, comprising the steps of detecting a subject with one or more detection sensors; collecting one or more electronic signatures of the subject with one or more electronic sensors; collecting biometric information of the subject with one or more biometric sensors; and determining if the internal database contains an existing record that matches any of the collected one or more electronic signatures and the collected biometric information.

According to another embodiment of the present disclosure, a biometric and electronic sensor system, comprising one or more detection sensors configured to detect the presence of a subject; one or more electronic sensors configured to detect electronic signatures of a subject; one or more biometric sensors configured to detect biometric information of a subject; an internal database configured to store one or more records; a processor operatively connected to the one or more detection sensors, one or more electronic sensors, one or more biometric sensors, and internal database; and a machine-readable storage medium encoded with computer program code operatively connected to the processor, and configured such that, when the computer program code is executed by the processor, the processor performs a method comprising the steps of detecting a subject with one or more detection sensors; collecting one or more electronic signatures of the subject with one or more electronic sensors; collecting biometric information of the subject with one or more biometric sensors; and determining if the internal database contains an existing record that matches any of the collected one or more electronic signatures and the collected biometric information.

### DESCRIPTION OF THE SEVERAL VIEWS OF THE DRAWINGS

FIG. 1 is a flow chart illustrating a method of the present disclosure.

FIG. 2 is a schematic illustrating a system of the present disclosure.

### DETAILED DESCRIPTION

The Biometric and Electronic Skimming Station (“BESS”) uses contactless biometric sensors such as cameras to collect biometric information on-the-move including face, height, mass, and other body part geometry such as hand geometry, and ear geometry, and also motion biometrics such as gate, or other movements. Iris-on-the move collection is also incorporated. Contactless fingerprints can also be collected using a high-resolution collection system. BESS may also incorporate a contact system for fingerprint collection or hand geometry to augment the biometric component collection. In addition BESS may check collected biometric information against watch lists or external databases that contain the biometric information of persons of interest to law enforcement and military organizations.

BESS uses electronic sensors to collect electronic signatures that can be “skimmed” or read either from emissions such as a cell phone or reflected emissions from RFID cards, tags, passports, magnetic strips, or credit cards. The advantage of BESS is that a person needs only to walk by the station and his iris, face, along with cell phone number, credit card number or passport number, or any similar information could all be collected. This is very unobtrusive and very fast with minor impact on slowing the person passing.

BESS may compare the collected electronic signatures to other external databases containing data that associates biographical data with electronic signatures. In this way BESS may determine biographical information such as name, social security number, address, phone number, date of birth, and related information that is associated with collected electronic signatures. BESS may check the collected electronic signatures and biographic information against watchlists or external databases that contain the electronic signatures and biographic information of persons of interest to law enforcement and military organizations. The combined collected biometric information, electronic signatures, biographic information, and watch list or external database matches could be combined into a single record.

BESS is applicable to any situation where it is desired to enroll individuals in a biometric identification management system. This includes situations where enrollees pass by a fixed enrollment station or where a mobile enrollment station travels amongst one or more enrollees. Such mobile enrollment stations may include stations covertly or overtly employed on driven vehicles, stations employed on lighter than air craft or unmanned aerial vehicles, helicopters, or manned aircraft. The sensors employed in BESS may be arranged separately around the area where the individuals are to be enrolled, or contained together in one or more compartments while still retaining their individual functionality. They may function with or without contacting the subject.

BESS addresses the problems of enabling enrollment in biometric identification management systems to take place at many locations and of many enrollees simultaneously; of reducing or eliminating the dependence of the enrollment process on the actions of human enrollers; and of collecting biometric and biographic information. It solves these problems without contacting the enrollees, without requiring them to stop, and without the enrollees being aware that biometric or biographical information is being collected.

BESS is activated by one or more detection sensors. The detection sensor may be any sensor, contact-based or contactless, that can alert BESS to the presence of a subject to be enrolled. Examples include an in-ground weight sensor, an infrared sensor, a motion sensor, or any electronic or biometric sensor such as those described below. Also, if a given detection sensor is an electronic or biometric sensor, it may operate in performing both the step of detecting a subject and collecting electronic signatures or biometric information.

BESS may also collect information on vehicles using the same sensors disclosed herein such as using an imaging sensor to collect the license plate of a passing vehicle.

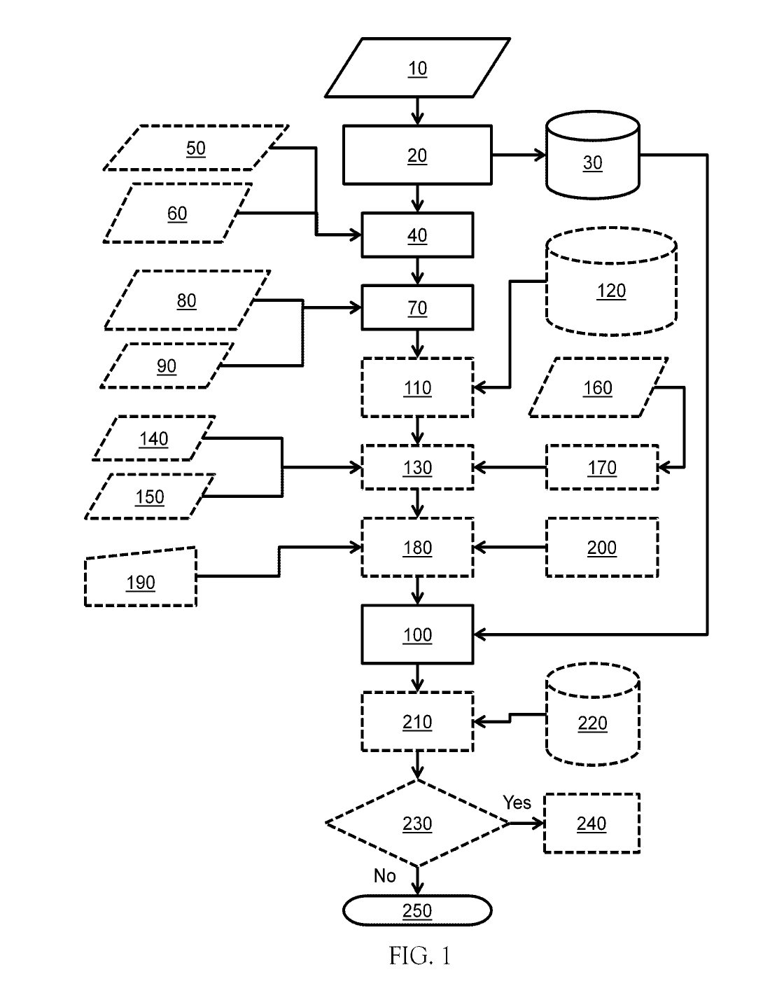

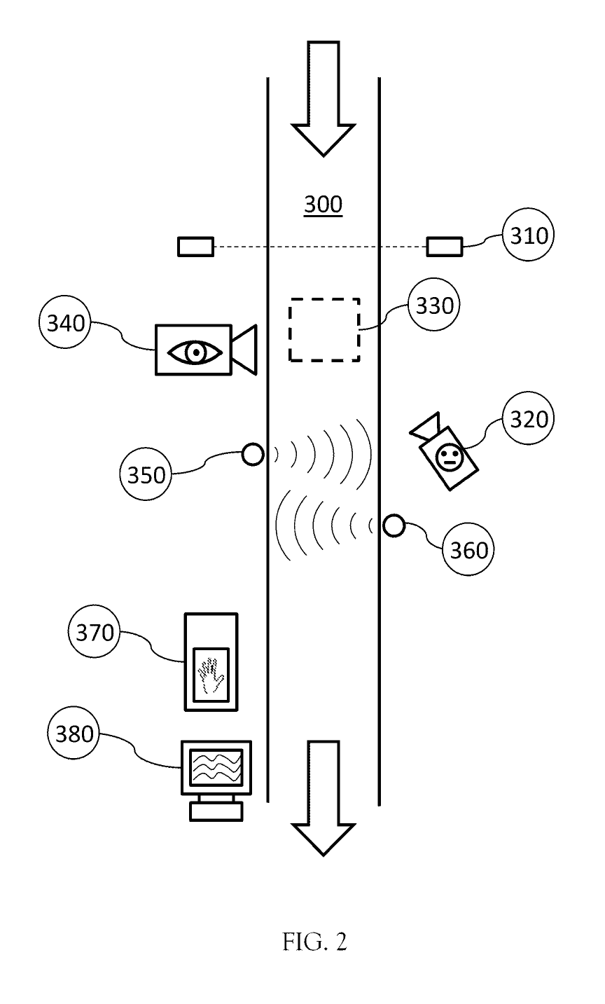

Now turning to FIG. 1 and FIG. 2, in one embodiment of the invention, the enrollee would walk along a path 300 with several covert stations along it. Upon entering the path 300, the enrollee would be detected at step 10 by a detection sensor such as an infrared light beam 310, a face recognition camera system 320, an in-ground weight sensor 330, or another method know to those knowledgeable in the arts. The system would then create at step 20 a new record for the enrollee in the internal database 30. However this step along with storage steps may also be performed later in the sequence once biometric information, electronic signatures, and biographic information have been collected. Biometric information such as weight, height, walking gate, or other visually observable information could be obtained without contacting the subject at step 40 and stored in the enrollee record. For example a camera system 320 could capture face images and body profile at step 50 while an iris scanner 340 could digitally record iris information at step 60. Other non-contact biometric devices may also be employed. In addition, contactless biometric information could also be gathered using similar sensors such as imaging devices that capture fingerprints or hand geometry. Electronic IDs or signatures would also be recorded at step 70 by electronic sensors or skimmers. RFID readers 350 could record data at step 80 from credit cards, passports, and identification cards, near field communication (NFC) devices or other devices that use RFID technology. Other electronic sensors 360 could record information at step 90 from cell phones, blue tooth, or other wireless devices. The data collected for the enrollee could then be compared at step 100 with enrollments in the internal database 30 to look for any discrepancies (for example, different irises for the same face).

In another embodiment, the electronic IDs or signatures gathered from the electronic sensors could be cross referenced at step 110 with external databases 120 to obtain biographical information such as name, social security number, address, phone number, date of birth, and related information that is associated with collected electronic signatures. Those knowledgeable in the art will recognize that this system could function in an overt environment with or without additional sensors or stations. Biometric data could be gathered by contact means at step 130 with additional devices known to those knowledgeable in the art. For example, a fingerprint or palm reader 370 could obtain hand biometrics at step 140 while a scale 330 obtained the enrollee's weight at step 150. DNA samples such as hair or body fluids may also be obtained at step 160 and the samples may be processed at step 170 to extract DNA code, either at the system site or remotely at a later time. Additional biographical or biometric information may also be requested at step 180 directly from the enrollee at a terminal 380. This could take the form of an interview process at step 190 where the enrollee answers questions or a form pre-filled by the enrollee could be scanned at step 200 for greater processing speed. The enrollee record could also be checked at step 210 for matches with existing databases 220 to verify data and check for discrepancies. If the enrollee matches a watchlist or is found in an automated fingerprint database, Interpol database, or FBI database, at step 230 the proper authorities could be notified at step 240. The process completes at step 250.

1. A method for biometric and electronic enrollment, comprising the steps of
detecting a subject with one or more detection sensors;
collecting one or more electronic signatures of the subject with one or more electronic sensors;
collecting biometric information of the subject with one or more biometric sensors; and
determining if the internal database contains an existing record that matches any of the collected one or more electronic signatures and the collected biometric information.

2. The method of claim 1, further comprising the step of determining if a first external database contains biographic information associated with the collected one or more electronic signatures.

3. The method of claim 1, further comprising the step of determining if a second external database contains a subject of interest that matches any of the collected one or more electronic signatures and the collected biometric information.

4. The method of claim 1, further comprising the steps of
creating a new record in an internal database; and
storing in the new record, the collected one or more electronic signatures, the collected biometric information, and a matching existing record determined to be contained in the internal database.

5. The method of claim 2, further comprising the steps of
creating a new record in an internal database; and
storing in the new record, the collected one or more electronic signatures, the collected biometric information, a matching existing record determined to be contained in the internal database, and associated biographic information determined to be contained in the first external database.

6. The method of claim 3, further comprising the steps of
creating a new record in an internal database; and
storing in the new record, the collected one or more electronic signatures, the collected biometric information, a matching existing record determined to be contained in the internal database, and a matching subject of interest determined to be contained in the second external database in the new record.

7. A biometric and electronic sensor system, comprising
one or more detection sensors configured to detect the presence of a subject;
one or more electronic sensors configured to detect electronic signatures of a subject;
one or more biometric sensors configured to detect biometric information of a subject;
an internal database configured to store one or more records;
a processor operatively connected to the one or more electronic sensors, one or more biometric sensors, and internal database; and
a machine-readable storage medium encoded with computer program code operatively connected to the processor, and configured such that, when the computer program code is executed by the processor, the processor performs a method comprising the steps of detecting a subject with one or more detection sensors; collecting one or more electronic signatures of the subject with one or more electronic sensors; collecting biometric information of the subject with one or more biometric sensors; and determining if the internal database contains an existing record that matches any of the collected one or more electronic signatures and the collected biometric information.

8. The biometric and electronic sensor system of claim 7, wherein the processor performs the method further comprising the step of determining if a first external database contains biographic information associated with the collected one or more electronic signatures.

9. The biometric and electronic sensor system of claim 7, wherein the processor performs the method further comprising the step of determining if a second external database contains a subject of interest that matches any of the collected one or more electronic signatures and the collected biometric information.

10. The biometric and electronic sensor system of claim 7, wherein the processor performs the method further comprising the steps of creating a new record in the internal database and storing the collected one or more electronic signatures, the collected biometric information, and a matching existing record determined to be contained in the internal database in the new record.

11. The biometric and electronic sensor system of claim 8, wherein the processor performs the method further comprising the steps of creating a new record in the internal database and storing associated biographic information determined to be contained in the first external database in the new record.

12. The biometric and electronic sensor system of claim 9, wherein the processor performs the method further comprising the steps of creating a new record in the internal database and storing a matching subject of interest determined to be contained in the second external database in the new record.
